(19) United States
(12) Patent Application Publication
(10) Pub. No.: US 2007/0060386 A1
(43) Pub. Date: Mar. 15, 2007

(54) Electronic money settlement system and electronic money information storage medium

(75) Inventors: Junichi Yamagishi, Chuo-ku (JP); Sakae Ayabe, Isehara-shi (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 11/516,806

(22) Filed: Sep. 6, 2006

(30) Foreign Application Priority Data
Sep. 9, 2005 (JP) 2005-263050

(51) Int. Cl. A63F 13/00

(52) U.S. Cl. 463/43

(57) ABSTRACT

An electronic money settlement system has a read/write unit configured to read electronic money information from the card, subtract a charge for an objective to be used by the user from the read electronic money information, and write the balance as new electronic money information into the card, the system also has a confirmation unit having a start button to provide a confirmation signal that confirms a start of use of the objective, and the confirmation signal makes the objective be ready and makes the read/write unit execute the subtraction.

### BACKGROUND OF THE INVENTION

1. Field of the Invention

The present invention relates to an electronic money settlement system and a storage medium such as a memory card for storing electronic money information.

2. Description of Related Art

Electronic money settlement systems employ various cards such as prepaid cards and credit cards.

The prepaid card holds a predetermined amount of money, and when the money is entirely consumed, the prepaid card is discarded. Namely, the prepaid card is not reused. The credit card is settled through a bank when a certain amount of money is used with the credit card. The credit card has a problem of excessively spending money and a security problem.

Recently developed is an electronic money card such as an Edy card (registered trademark) which is a noncontact IC card storing electronic money information. When the electronic money card is used to purchase a commodity, the price of the commodity is subtracted for payment from the stored electronic money and the balance is written into the electronic money card.

The electronic money card is less problematic than the prepaid card and credit card and is safely reusable.

The electronic money card may be used in, for example, a game arcade. In this case, the electronic money card is set in a read/write unit associated with a game machine. The read/write unit reads electronic money information from the electronic money card, subtracts a game charge from the electronic money information, and writes the balance into the electronic money card. After setting the electronic money card in the game machine, the user of the electronic money card may rethink not to play the game machine. In this case, the user has no way to receive a refund of the subtracted game charge. This is inconvenient for the user.

The related art mentioned above is disclosed in, for example, Japanese Unexamined Patent Application Publication No. 2005-107734.

### SUMMARY OF THE INVENTION

An object of the present invention is to provide an electronic money settlement system capable of refinding money to a user even after an electronic money card is set in, for example, a game machine, thereby providing the user with satisfactory service.

In order to accomplish the object, an aspect of the present invention provides an electronic money settlement system for a storage medium storing electronic money information. The system includes a read/write unit configured to read the electronic money information from the storage medium, subtract a charge for using an objective from the read electronic money information, and write the balance as new electronic money information into the storage medium and a confirmation unit configured to provide a confirmation signal that confirms a start of use of the objective, makes the objective be ready, and makes the read/write unit execute the subtraction.

According to this aspect of the present invention, the read/write unit reads electronic money information from a storage medium, subtracts a charge for using an objective from the read electronic money information, and writes the balance as new electronic money information into the storage medium. The confirmation unit provides a confirmation signal. In response to the confirmation signal, the objective becomes usable and the read/write unit executes the subtraction. This aspect allows a user of the storage medium to effectively use the electronic money stored in the storage medium and properly receive service.

In this way, the present invention provides the user of an electronic money card with appropriate service without wasting money.

### BRIEF DESCRIPTION OF THE DRAWINGS

FIG. 1 is a schematic view showing a game arcade employing an electronic money settlement system according to an embodiment of the present invention; and

FIG. 2 is a schematic view showing relationships among an electronic money card, a game machine, an administration unit, and a deposit/refund unit in the system of FIG. 1.

### DETAILED DESCRIPTION OF EMBODIMENTS

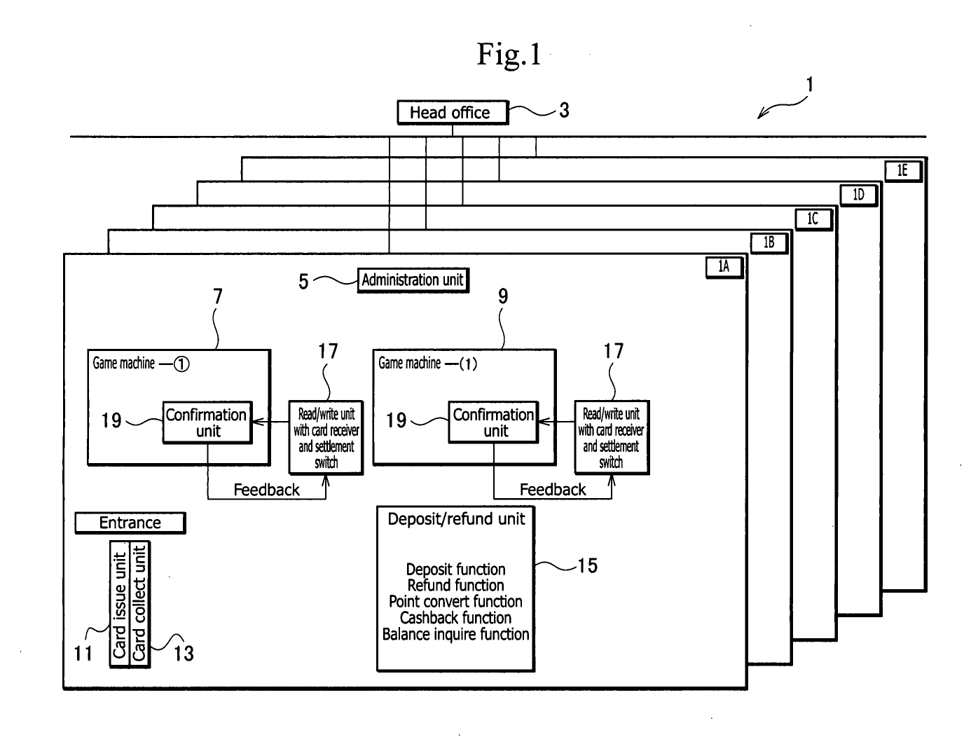

FIG. 1 is a schematic view showing a game arcade employing an electronic money settlement system according to an embodiment of the present invention.

In FIG. 1, the electronic money settlement system is applied to each of a plurality of game arcades 1 represented with numerals of 1A, 1B, 1C, 1D and 1E as amusement places. The game arcades 1 (1A to 1E) are centrally managed by a head office 3. The game arcades 1 (1A to 1E) have the same configuration, and therefore, the game arcade 1 (1A) will be explained as a representative.

The game arcade 1 has an administration unit 5 that is accessible from the head office 3 so that the head office 3 can collect information of the sales of the game arcade 1 and manage the game arcade 1. The administration unit 5 has a read/write unit for reading and writing an electronic money card and a database. The game arcade 1 has a plurality of game machines 7, 9, and the like, a card issue unit 11, a card collect unit 13, and a deposit/refund unit 15.

Each game machine (7, 9, . . . ) has a read/write unit 17 to read and write an electronic money card and a confirmation unit 19 to determine whether or not the game machine must be started. The read/write unit 17 reads electronic money information or available points from an electronic money card, subtracts a charge for a game played with the game machine from the electronic money or points, and writes the balance or remaining points into the electronic money card.

Which of the electronic money and available points must be used by priority may be set in advance in the read/write unit 17. For example, the available points are used at first, and if the charge for the game is higher than the available points, the excess will be deducted from the electronic money. Alternatively, the electronic money is used at first, and according to the user's instruction, the available points are partly or wholly used. It is possible to set so that the user may determine which of the electronic money and available points must be used by priority.

In this embodiment, the available points are equivalent to electronic money and are included in the electronic money information.

The confirmation unit 19 outputs a confirmation signal in response to, for example, operation of a start button arranged on the confirmation unit 19. The confirmation signal is a trigger to actually start the game machine (7, 9, . . . ). The confirmation signal to start the game machine is fed back as a start signal to the read/write unit 17. Namely, the confirmation unit 19 is used to confirm whether or not the objective game machine is actually used. In response to the fed-back start signal, the read/write unit 17 subtracts the charge for the game after the end of the game.

The confirmation unit 19 may be arranged at a location other than the game machine.

The card issue unit 11 and card collect unit 13 are arranged at the entrance of the game arcade 1. When a user inserts initial deposit money into the card issue unit 11, the card issue unit 11 issues a blank electronic money card for the user. The card collect unit 13 collects the electronic money card when the user exits the game arcade 1 and returns the initial deposit money to the user.

The deposit/refund unit 15 has a deposit function, a refind function, a point convert function, a cashback function, and a balance inquire function. With the deposit function, when the user inserts the electronic money card and deposit money into the deposit/refund unit 15, the deposit/refund unit 15 inputs electronic money information representative of an amount of the deposit money into the electronic money card. With the refund function, the deposit/refund unit 15 returns money to the user if there is a balance in the electronic money information of the electronic money card and zeroes the balance in the electronic money information. With the balance inquire function, the deposit/refund unit 15 outputs a balance in the electronic money information of the electronic money card so that the user may recognize the balance. The point convert function and cashback function will be explained later. Cash-flow data of the deposit/refind unit 15 is transmitted to the administration unit 5 by wireless or wire.

At the entrance of the game arcade 1, a user inserts initial deposit money into the card issue unit 11, receives a blank electronic money card from the card issue unit 11. Thereafter, the user inserts the electronic money card and a certain amount of money into the deposit/refund unit 15, and receives from the deposit/refind unit 15 the electronic money card holding electronic money information representative of the inserted amount of money.

The user sets the electronic money card in the read/write unit 17 of a desired one of the game machines 7, 9, and the like so that the read/write unit 17 may read the electronic money information or available points from the electronic money card. The user may operate a start button on the game machine, to start a game. The confirmation unit 19 checks to see if the game has actually been started, and if started, feeds a confirmation signal back to the read/write unit 17. In response to the confirmation signal, the read/write unit 17 subtracts a charge of the game or a cumulative charge accumulated after the game start from the read electronic money information or available points and writes the balance as new electronic money information into the electronic money card, thereby settling the game charge.

Amounts of money and available points spent on the game machines of the game arcade 1 are transmitted to the administration unit 5 of the game arcade 1 by wireless or wire. The head office 3 accesses the administration unit 5 of each shop, to manage the sales and the like of the shops.

After a game play with the game machine, the user picks up the electronic money card that has already made a payment for the game machine as settlement for the game play and moves to another game machine or ends the game play.

When exiting the game arcade 1, the user inserts the electronic money card into the card collect unit 13, so that the card collect unit 13 may collect the electronic money card. At this time, if the electronic money card has no pending charge or no balance, the card collect unit 13 refunds the initial deposit money for the electronic money card to the user.

Alternatively, the system may make the user carry the electronic money card to lead the user to visit the game arcade 1 again.

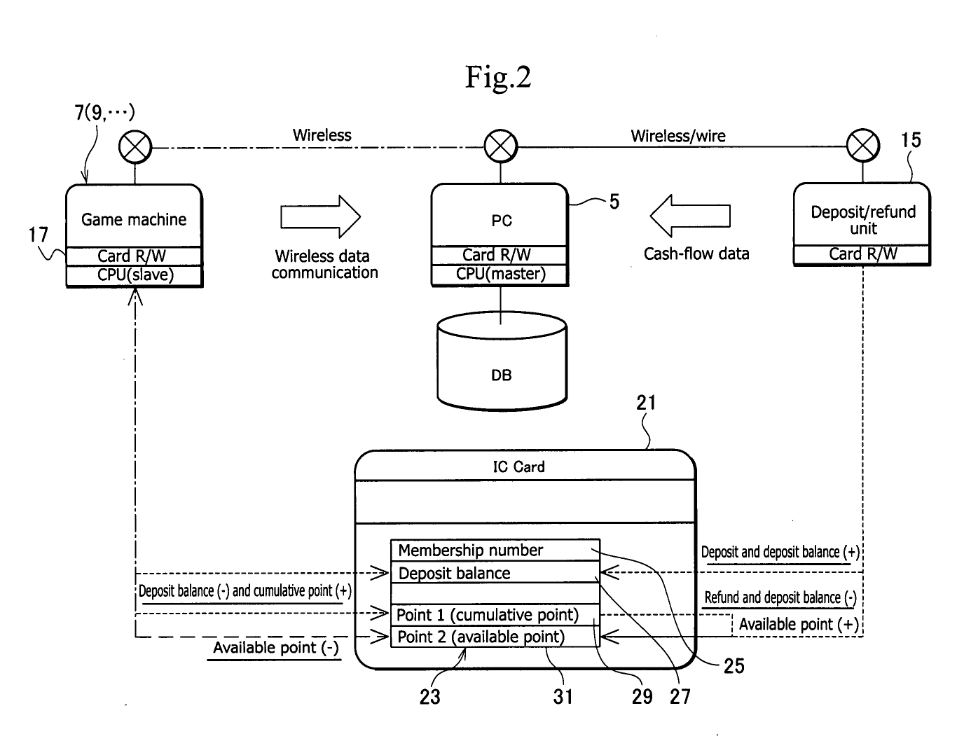

FIG. 2 is a schematic view showing relationships among the electronic money card, game machine, administration unit, and deposit/refund unit in the system of FIG. 1.

In FIG. 2, the electronic money card 21 is, for example, an IC card having an IC module provided with an IC contact.

The IC module has a memory 23. The memory 23 includes a membership number storage area 25, an electronic money storage area 27, a cumulative point storage area 29, and a point storage area 31.

The membership number storage area 25 stores a user's membership number. The electronic money storage area 27 stores electronic money information. The cumulative point storage area 29 stores cumulative points that are accumulated whenever electronic money is spent. The point storage area 31 stores point information representative of available points.

The user is allowed to select whether the cumulative points are converted into available points to be stored in the point storage area 31 or into cashback money as bonus. If the cumulative points are converted into cashback, the deposit/refund unit 15 pays money to the user according to cashback money. This selection is carried out with the deposit/refund unit 15. Converting the cumulative points into available points to be stored in the point storage area 31 is carried out by the point convert function of the deposit/refund unit 15. Converting the cumulative points into cashback money is carried out by the cashback function of the deposit/refund unit 15.

The cumulative points in the cumulative point storage area 29 may be converted into available points to be stored in the point storage area 31 and cashback money according to a predetermined condition. The predetermined condition may be that if the sum of the cumulative points exceeds a threshold, or any other.

The cumulative points in the cumulative point storage area 29 are increased whenever electronic money in the electronic money card is used. For example, a charge for a game machine is multiplied by a coefficient to calculate cumulative points to be added, or the charge itself is used as points and the cumulative points are increased by the points.

The coefficient may be differed depending on the game machines (7, 9, . . . ). For example, unpopular game machines may have higher coefficients to rapidly increase the cumulative points in the cumulative point storage area 29. Naturally, it is possible to set the same coefficient for all game machines.

As mentioned above, the read/write unit 17 reads electronic money information from the electronic money card 21, subtracts a charge for an objective (game machine) from the read electronic money information, and writes the balance as new electronic money information into the electronic money card 21. The confirmation unit 19 may be associated with a start button of the game machine (7, 9, . . . ). When the start button is pushed, the game machine is started and the confirmation unit 19 issues a confirmation signal. In response to the confirmation signal, the read/write unit 17 subtracts a charge for the game machine from the electronic money information in the electronic money card 21 and writes the balance as new electronic money information into the electronic money card 21. Accordingly, the user of the electronic money card 21 can properly receive service, i.e., properly play with the game machine without wasting money.

The present invention is applicable not only to the settlement of a play charge in a game arcade but also to any other settlement such as the settlement of purchasing a commodity.

The storage medium for storing electronic money information according to the present invention is applicable not only to electronic money cards but also to cellular phones.

What is claimed is:

1. An electronic money settlement system for a storage medium storing electronic money information, comprising:
a read/write unit configured to read the electronic money information from the storage medium, subtract a charge for using an objective from the read electronic money information, and write the balance as new electronic money information into the storage medium; and
a confirmation unit configured to provide a confirmation signal that confirms a start of use of the objective, makes the objective be ready, and makes the read/write unit execute the subtraction.

2. The system of claim 1, wherein the confirmation unit is arranged on the objective.
